(19) United States
(12) Patent Application Publication
(10) Pub. No.: US 2013/0109362 A1
(43) Pub. Date: May 2, 2013

(54) TELEPHONE CALL BLOCKING

(71) Applicant: Howard Simms, Lancashire (GB)

(72) Inventor: Howard Simms, Lancashire (GB)

(73) Assignee: Panaram Limited, Lancashire (GB)

(21) Appl. No.: 13/695,177

(22) PCT Filed: Apr. 27, 2011
(86) PCT No.: PCT/GB11/50833

§ 371 Date: Jan. 17, 2013

(30) Foreign Application Priority Data
Apr. 27, 2010 (GB) 1006996.1

(51) Int. Cl. H04W 4/16

(52) U.S. Cl. CPC H04W 4/16
USPC 455/414.1

(57) ABSTRACT

The present invention relates to controlling the operation of one or more controlled handsets. This is achieved by means of a filtering engine incorporated into the handset, to disable the handset from making unauthorized connections. The filtering engine is operable to communicate with a master handset or a system controller. This can allow review of the control operation and may additionally allow rapid update of the filtering criteria. In one typical example, the master handset may be held by a parent, guardian or other responsible adult and the controlled handsets may be held by one or more children. In an alternative example, it may be possible for the master handset to be held by a supervisor and the controlled handsets to be provided to supervised workers.

The present invention relates to telephone call blocking and in particular to a telephone handset operable to implement automatic telephone call blocking.

In the present day there occur circumstances wherein one party may provide a cellular telephone for use by the other party. In such cases, the providing party may wish to have some control over the use of the phone. In one example, the providing party may be a parent who is providing a telephone for their child. The parent may wish to restrict the child's ability to call inappropriate numbers and thereby run up large charges and/or potentially expose themselves to inappropriate others. In the present market place, this is achieved by providing a telephone handset of limited capability. Typically, such a handset will provide dedicated inputs which upon actuation cause the handset to call a parent, a school or the like and the emergency services. The handset will however be unable to freely dial other numbers. Such handsets are inflexible in terms of operation, since safe numbers need to be input directly to the handset. In the event of a parent's number changing or other problem with their connection, the child can no longer contact the parent. They are also typically unpopular with children due to the lack of features.

It is therefore an object of the present invention to provide an apparatus and/or method by means of which the above problems can be at least partially overcome or alleviated.

In accordance with a first aspect of the present invention there is provided a cellular telephone handset of the type operable to connect voice calls or messages to other handsets or devices, the handset comprising: user interface means for requesting a connection to another handset or device; connection means for providing the requested connection via a suitable network; and a filtering engine comprising: a connection identification unit operable to identify the requested connection; a comparison unit operable to compare the requested connection with a stored list of connections to determine whether the requested connection is permitted; a connection enabling unit operable in response to the comparison unit to enable or disable the connection means; and a messaging engine operable to communicate with a separate controller device via the connection means to maintain and/or update said stored list.

The provision of the filtering engine in the handset allows the handset to autonomously enable or disable requested connections. Beneficially, since the filtering engine can communicate with a separate controller device to maintain or update the stored list, this can be monitored or controlled by a person other than the user of the handset.

The connection may be a voice call. Additionally or alternatively, the connection may be a message for sending to another handset or device. Such messages may be text based (e.g. SMS or the like) or multimedia messages (e.g. MMS or the like). Additionally or alternatively, the connection may be a connection to a social networking platform. As such, the connection means may incorporate call connection means for connecting voice calls, message connection means for sending messages and/or social networking connection means for connecting to one or more social networking platforms.

The connection means may be operable to connect the handset using any suitable communications network. Typically the communications network would be a cellular communications network running to an agreed standard. Examples would include, but are not limited to 3G, GPRS, GSM and the like. Additionally or alternatively, the network may be any other suitable form of wireless network such as a WiFi network, Bluetooth or the like.

The requested connection may be identified by any suitable identifier such as a telephone number or other suitable addressing scheme such as a web address for a social networking platform.

The comparison unit may store one or more lists. The or each list may comprise a list of approved connections or a list of unapproved connections. There may be one or more list of each type stored by the comparison unit. The appropriate list for use when a connection is requested may be selected by reference to criteria including but not limited to: type of connection, time of request or location of handset. By providing differing lists for type of requested connection, there may be different restrictions placed on voice calls and text message, for example or voice calls, messaging and social networking as another example. The time and/or location may be determined by reference to a local network cell. This can prevent a user circumventing the operation of the filtering engine. By providing differing time and/or location based lists, it may be possible for the handset to automatically switch between, for example, a ‘school’ mode where connection is highly restricted and an ‘after school’ mode where connections are less restricted.

The or each list may be fixed or may be updateable. The comparison unit may update lists in response to update messages from the controller device. Additionally or alternatively, the stored lists may be updated automatically at regular intervals.

The connection enabling unit may be operable in response to the comparison unit to enable all requested connections to the selected approved list. The connection enabling unit may be operable in response to the comparison unit to disable all requested connections to the selected unapproved list. The connection enabling unit may be operable in response to the comparison unit to either enable or disable all requested connections that are not on the selected approved list or the selected unapproved list, as desired or as appropriate.

The messaging engine may be operable in response to the comparison unit to communicate with the controller device in response to requested connections that are on the selected unapproved list or that are not on the selected approved list or the selected unapproved list. In response to requested connections that are on the selected unapproved list, the communication may be a reporting message containing the details of the requested connection.

In response to requested connections that are not on the selected approved list or the selected unapproved list, the messaging engine may communicate with the controller device. The communication may comprise an update request for the selected lists. The update request may comprise an automatically populated message containing details of the requested connection. The update request may be communicated automatically or may require user approval before communication. In response to the update request, an update message may be communicated by the controller device. The update message may direct the comparison unit to add the requested connection to either the approved or unapproved list. The update message may be displayed to the handset user upon receipt. The update request may comprise data allowing an automatically populated update message to be generated at the controller device.

The messaging engine may be operable to generate or receive messages relating to monitoring handset operation in addition to messages relating to maintaining and/or updating the one or more stored lists. The filtering engine may maintain an operation log. The operation log may contain details of any or all of requested connections; enabled requested connections; or disabled requested connections. The messaging engine may be operable to generate a log reporting message containing details of the log for communication to the controller device. The messaging engine may be operable to generate log reporting messages at predetermined time or intervals and/or in response to received messages. The reporting messages may be communicated automatically or may require user approval before communication.

The controller device may be another handset designated as a master handset. The master handset may be act as master handset to one or more controlled handsets. The master handset and the or each controlled handset may communicate directly. Additionally or alternatively communications between the master handset and the or each controlled handset may be copied to a system controller or may be made via a system controller. In some embodiments, log reporting messages may be communicated to the system controller rather than directly to the master handset. In such cases, the master handset may be operable to connect to the system controller to access details of the log for the or each controlled handset. Alternatively, an internet user interface may be provided to enable the user of the master handset to view these details via another suitable device. The internet user interface may be provided on an application server. The application server may comprise a payment gateway or may be connected to an external payment gateway.

The system controller may be operable with one or more master handsets, each master handset controlling one or more controlled handsets. The system controller may comprise a database containing details of the or each master handset and the or each controlled handset associated with a master handset. The database may further comprise details of the or each approved or unapproved connection list for the or each controlled handset.

The system controller may comprise a management module operable to control the database. The management module may control the database in response to: update requests from controlled handsets; update messages from master handsets; log reporting messages; communications from the payment gateway or similar.

The system controller may comprise or be connected to a messaging gateway to enable communication between the system controller and the or each handset. Where appropriate, communication may additionally or alternatively be effected via a connection from the application server to the internet.

The master handset may comprise a filtering control engine operable to receive and display communications from the or each controlled handset. The filtering control engine may further be operable to generate and send an update message to a controlled handset. The update message may be generated autonomously or in response to a received update request.

In accordance with a second aspect of the present invention there is provided a system comprising: one or more controlled handsets according to the first aspect of the present invention; and a master handset operable to communicate with the or each controlled handset, the master handset further comprising: a filtering control engine operable to receive and display communications from the or each controlled handset and operable to generate and send an update messages to the or each controlled handset.

The system of the second aspect of the present invention may incorporate any and or all aspects of the handset of the first aspect of the present invention as desired or as appropriate.

In accordance with a third aspect of the present invention there is provided a system controller for use with one or more controlled handsets according to the first aspect of the present invention or for use with a system according to the second aspect of the present invention, the system controller comprising: a database storing details relating to the or each handset; an application server providing an interne user interface; a management module operable to control the database and the application server and operable to initiate, monitor or respond to communication from the or each handset.

The system controller of the third aspect of the present invention may incorporate any and or all aspects of the handset of the first aspect of the present invention or the system of the second aspect of the present invention as desired or as appropriate.

In order that the invention is more clearly understood, one embodiment is now described further herein, with reference to the accompanying drawings, in which:—

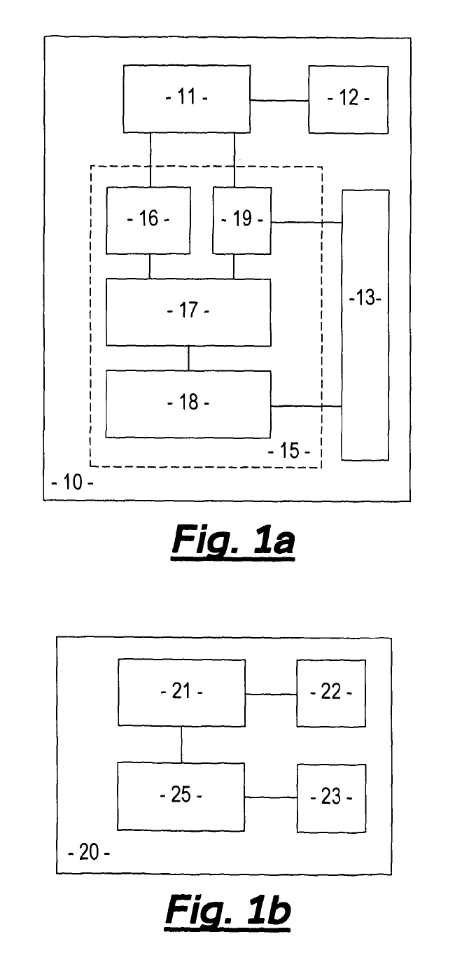

FIG. 1a is a schematic block diagram of a cellular phone handset according to the present invention;

FIG. 1b is a schematic block diagram of a master cellular phone handset for controlling the operation of the handset of FIG. 1; and

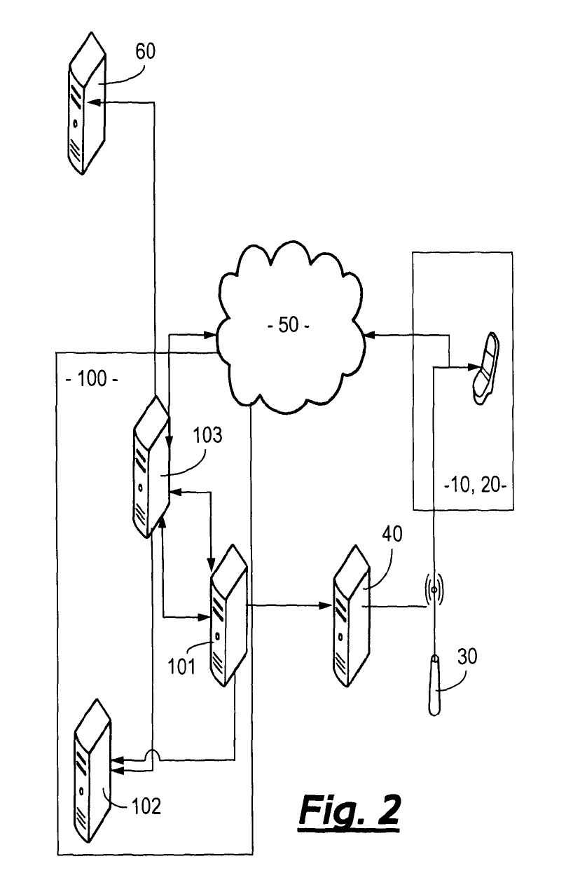

FIG. 2 is a schematic block diagram of a system controller for controlling one or more handsets of FIG. 1.

The present invention relates to controlling the operation of one or more controlled handsets 10. This is achieved by means of a filtering engine 15 incorporated into the handset 10, to disable the handset 10 from making unauthorised connections. The filtering engine is operable to communicate with a master handset 20 or a system controller 100. This can allow review of the control operation and may additionally allow rapid update of the filtering criteria. In one typical example, the master handset 20 may be held by a parent, guardian or other responsible adult and the controlled handsets may be held by one or more children. In an alternative example, it may be possible for the master handset to be held by a supervisor and the controlled handsets to be provided to supervised workers.

Referring now to FIG. 1a, a controlled handset 10 comprises a user interface 11, a display screen 12 and a connection means 13. The user interface may comprise user actuable controls and may be incorporated with the display screen 12 if desired. The user interface allows the user to request that a connection (such as a voice call, text based message or multimedia message) be made to a particular number or that a connection be made to a social networking platform whether for upload, download and/or browsing purposes.

The connection means 13 is operable to provide the requested connection via a suitable network. Typically the network would be a cellular telephone network but may be another form of data network if desired.

The filtering engine 15 is provided between the interface 11 and the connection means 13. The filtering engine comprises a connection identification unit 16, a comparison unit 17, a connection enabling unit 18 and a messaging engine 19.

The connection identification unit 16 is operable to identify the requested connection. Typically, this is achieved by determining the telephone number of the requested connection.

The comparison unit 17 is operable to compare the requested connection with a stored list of connections to determine whether the requested connection is permitted. Typically, there is more than one stored list of connections. In a preferred example there is at least a ‘white’ list of approved connections and a ‘black’ list of unapproved connections. There may be more than one white list and/or more than one black list. In such cases, the appropriate list is selected by reference to additional criteria such as type of connection, local time or handset location

The connection enabling unit 18 operable in response to the comparison unit 17 to enable or disable the connection means 13. The messaging engine 19 is operable to communicate with the master handset 20 (or any other separate controller device) via the connection means 13. This allows the or each stored list to be monitored, maintained and/or updated, as required.

In typical use, the when a connection is requested by the user interface 11, this is identified by the connection identification unit 16 and compared against the appropriate white and black lists by the comparison unit 17. If the requested connection is determined to be on the white list, the connection enabling unit 18 enables the connection means 13 thus allowing the connection to be made. If the requested connection is determined to be on the black list, the connection enabling unit 18 disables the connection means 13 thus preventing the connection being made.

If a requested connection is not on the black list or the white list, it may be automatically enabled or automatically disabled, according to the operational settings of the connection enabling means 18. In some modes the connection enabling unit 18 may enable such connections. In other modes, the connection enabling unit 18 may disable such connections. In addition to disabling such connections, the messaging unit 19 may be operable in response to send a message to the master handset 20 indicating that a black list connection has been requested along with other related details of the connection request.

In a further alternative, if a requested connection is not on the black list or the white list, the connections may be disabled and the messaging unit may be activated. In such cases, the messaging unit 19 may be operable to generate and populate a list update message to be sent to the master handset 20 via the connection means 13. In response, the messaging unit 19 may receive via the connection means 13 an update message. The update message may result in the requested connection being added to the white list or the black list, as appropriate.

Turning now to FIG. 1b, a master handset comprises a user interface 21, a display screen 22 and a connection means 23. The user interface may comprise user actuable controls and may be incorporated with the display screen 22 if desired. The user interface allows the user to request that a connection (such as a voice call, text based message or multimedia message) be made to a particular number.

The connection means 23 is operable to provide the requested connection via a suitable network. Typically the network would be a cellular telephone network but may be another form of data network if desired.

The master handset 20 further comprises a filtering control engine 25 operable to receive communications from the or each controlled handset 10. The communications may then be displayed on display screen 22. The filtering control engine 25 is further operable to generate and send an update message to a controlled handset 10. The update message may be generated autonomously by the filtering control engine 25 or may be generated in response to a received update request.

Communication between the master handset 20 and the controlled handsets 10 may be direct via a suitable communications network. Additionally or alternatively, communications may be copied to or transmitted via a system controller 100, a schematic view of the system controller 100 is shown in FIG. 2.

The system controller 100 comprises a management module 101, a database 102 and an application server 103. The database 102 is operable to store details relating to the or each handset 10, 20 and any associated white or black lists. The application server 103 is adapted to provide an internet connection and an internet user interface by means of which users of master handsets 20 at least may connect to the system controller 100. The management module 101 is operable to control the database 102 and the application server 103. The management module 101 is also operable to initiate, monitor or respond to communication from the or each handset 10, 20. This can be achieved via the internet 50 using the connection provided by application server 103 or via a messaging gateway 40 connected to a mobile communications network 30.

In one example of use, a parent may wish to use the present invention to control the use of a mobile phone handset by their child. As a first step, the parent logs on to the user interface of the application server 103. They can then enter any necessary details (model number, telephone number etc) of their master handset 20 and the child's handset 10, which is to be monitored and controlled.

The parent may at this stage set up one or more white or black lists. These can be bespoke lists or may be copied from or edited from templates provided by, for instance, the child's school. Typically, a white list might include, at least, the parent's number, the school's number and emergency numbers whilst a black list might include, at least, premium rate and adult content numbers.

The parent may also set the criteria, e.g. time of day for switching between lists. Accordingly, a child might be prevented from making a phone connection to friends during school hours but may be free to do so after school.

The parent can later log back on to the application server, to view or vary derails relating to the account as necessary or as desired.

The parent may also enter any requite payment details at this stage. The payments can be handled directly by the application server 103 or alternatively by way of a connection to an external payment gateway 60, as is shown in FIG. 2.

Once an account is set up, the each handset 10, 20 is provided with any necessary features, typically by way of an application delivered via SMS through gateway 40 and network 30. Once the application is installed on each handset 10, 20, it may send an activation confirmation message to the management module 101. The management module may in turn transmit one or more white or black lists to the handset 10 for storage by the comparison unit 17.

In user, the filtering engine 15 installed on handset 10 is typically operable to keep a log of all requested connections and upload a log reporting message to the management module 101 on a regular, e.g. daily basis. The connection log details may then be stored in database 102.

Whenever the child uses handset 10 to make a connection, it is determined by the comparison unit 17 whether the connection is on the applicable white list or black list. If the requested connection is on the white list, it is enabled and proceeds as normal. If the requested connection is on the black list, it is disabled. Furthermore, the messaging unit 19 generates a message which is sent to the parents handset 20 providing details of the disabled connection.

If the requested connection is on neither of the applicable white and black lists, the connection is disabled. In addition a message is generated by messaging unit 19 and displayed on display screen 12. The message is an update request related to the connection and the child is prompted to indicate whether they wish to request permission to contact this number. If the child selects not to request permission, the message is deleted and the applicable black and white lists are unchanged. If the child chooses to seek permission, the message is sent to the parent's handset 20.

At the parents handset, the message is displayed on screen 22 and the parent is prompted to indicate whether they will grant permission. If the parent selects no, the number can be added to the black list. If the parent selects yes, the number can be added to white list. In each instance an update message is then sent to the child's handset 10, allowing the relevant lists to be updated.

It is of course to be understood that the invention is not to be limited to the details of the above embodiment which is described by way of example only.

1. A cellular telephone handset of the type operable to connect voice calls or messages to other handsets or devices, the handset comprising:
a user interface means for requesting a connection to another handset or device;
a connection means for providing the requested connection via a suitable network; and
a filtering engine comprising:
a connection identification unit operable to identify the requested connection;
a comparison unit operable to compare the requested connection with a stored list of connections to determine whether the requested connection is permitted;
a connection enabling unit operable in response to the comparison unit to enable or disable the connection means; and
a messaging engine operable to communicate with a separate controller device via the connection means to maintain and/or update said stored list.

2. A cellular telephone handset as claimed in claim 1 wherein the connection is a voice call, a message for sending to another handset or device or a connection to a social networking platform.

3. A cellular telephone handset as claimed in claim 1 wherein the connection means incorporates call connection means for connecting voice calls, message connection means for sending messages or a social networking connection means for connecting to one or more social networking platforms.

4. A cellular telephone handset as claimed in claim 1 wherein the comparison unit stores one or more lists comprising approved connections or unapproved connections.

5. A cellular telephone handset as claimed in claim 4 wherein the appropriate list for use when a connection is requested is selected by reference to criteria including: type of connection, time of request or location of handset.

6. A cellular telephone handset as claimed in claim 5 wherein time and/or location are determined by reference to a local network cell.

7. A cellular telephone handset as claimed in claim 4 wherein the comparison unit may update lists in response to update messages from the controller device or wherein the stored lists are updated automatically at regular intervals

8. A cellular telephone handset as claimed in claim 4 wherein the connection enabling unit is operable in response to the comparison unit to enable all requested connections to the selected approved list.

9. A cellular telephone handset as claimed in claim 4 wherein the connection enabling unit is operable in response to the comparison unit to disable all requested connections to the selected unapproved list.

10. A cellular telephone handset as claimed in claim 4 wherein the connection enabling unit is operable in response to the comparison unit to either enable or disable all requested connections that are not on the selected approved list or the selected unapproved list.

11. A cellular telephone handset as claimed in claim 4 wherein the messaging engine is operable in response to the comparison unit to communicate with the controller device in response to requested connections that are on the selected unapproved list or that are not on the selected approved list or the selected unapproved list.

12. A cellular telephone handset as claimed in claim 11 wherein in response to requested connections that are on the selected unapproved list, the communication is a reporting message containing the details of the requested connection and wherein in response to requested connections that are not on the selected approved list or the selected unapproved list, the messaging engine communicates with the controller device.

13. A cellular telephone handset as claimed in claim 12 wherein the communication is an update request comprising an automatically populated message containing details of the requested connection.

14. A cellular telephone handset as claimed in claim 13 wherein the update request is communicated automatically or require user approval before communication.

15. A cellular telephone handset as claimed in claim 14 wherein in response to the update request, an update message is communicated by the controller device, the update message directing the comparison unit to add the requested connection to either the approved or unapproved list.

16. A cellular telephone handset as claimed in claim 15 wherein the update request comprises data allowing an automatically populated update message to be generated at the controller device.

17. A cellular telephone handset as claimed in claim 11 wherein the messaging engine is operable to generate or receive messages relating to monitoring handset operation in addition to messages relating to maintaining and/or updating the one or more stored lists.

18. A cellular telephone handset as claimed in claim 1 wherein the filtering engine maintains an operation log containing details of any or all of: requested connections; enabled requested connections; or disabled requested connections.

19. A cellular telephone handset as claimed in claim 18 wherein the messaging engine is operable to generate a log reporting message containing details of the log for communication to the controller device.

20. A cellular telephone handset as claimed in claim 1 wherein the controller device is another handset designated as a master handset.

21. A cellular telephone handset as claimed in claim 20 wherein the master handset acts as master handset to one or more controlled handsets.

22. A cellular telephone handset as claimed in claim 21 wherein the master handset and the or each controlled handset communicate directly.

23. A cellular telephone handset as claimed in claim 21 wherein communications between the master handset and the or each controlled handset are copied to a system controller or are made via a system controller.

24. A cellular telephone handset as claimed in claim 23 wherein log reporting messages are communicated to the system controller rather than directly to the master handset.

25. A cellular telephone handset as claimed in claim 24 wherein the master handset is operable to connect to the system controller to access details of the log for the or each controlled handset.

26. A cellular telephone handset as claimed in claim 25 wherein an internet user interface is provided to enable the user of the master handset to view these details via another suitable device.

27. A system comprising:
one or more controlled handsets comprising:
a user interface means for requesting a connection to another handset or device;
a connection means for providing the requested connection via a suitable network; and
a filtering engine comprising:
a connection identification unit operable to identify the requested connection;
a comparison unit operable to compare the requested connection with a stored list of connections to determine whether the requested connection is permitted;
a connection enabling unit operable in response to the comparison unit to enable or disable the connection means; and
a messaging engine operable to communicate with a separate controller device via the connection means to maintain and/or update said stored list; and
a master handset operable to communicate with the or each controlled handset, the master handset further comprising: a filtering control engine operable to receive and display communications from the or each controlled handset and operable to generate and send an update messages to the or each controlled handset.

28. A system as claimed in claim 27 wherein the filtering control engine is operable to generate and send an update message to a controlled handset.

29. A system as claimed in claim 28 wherein the update message is generated autonomously or in response to a received update request.

30. A system as claim in claim 27 further comprising a system controller including:
a database storing details relating to the or each handset; an application server providing an internet user interface; a management module operable to control the database and the application server and operable to initiate, monitor or respond to communication from the or each handset.

31. A system as claimed in claim 30 wherein the system controller is operable with one or more master handsets, each master handset controlling one or more controlled handsets.

32. A system as claimed in claim 31 wherein the system controller comprises a database containing details of the or each master handset and the or each controlled handset associated with a master handset.

33. A system as claimed in claim 30 wherein the database comprises details of the or each approved or unapproved connection list for the or each controlled handset.

34. A system as claimed in claim 30 wherein the system controller comprises a management module operable to control the database in response to: update requests from controlled handsets; update messages from master handsets; log reporting messages; or communications from the payment.

35. A system as claimed in claim 30 wherein the system controller comprises or is connected to a messaging gateway to enable communication between the system controller and the or each handset.

36. A system as claimed in claim 30 wherein communication additionally or alternatively is effected via a connection from the application server to the internet.
